(19) United States
(12) Patent Application Publication
(10) Pub. No.: US 2026/0106176 A1
(43) Pub. Date: Apr. 16, 2026

(54) CURRENT COLLECTOR AND BATTERY

(71) Applicant: TOYOTA JIDOSHA KABUSHIKI KAISHA, Toyota-shi (JP)

(72) Inventors: Satoshi Moriyama, Nagoya-shi (JP); Tetsuya Mimura, Chiryu-shi (JP); Atsushi Sugihara, Toyota-shi (JP); Masayoshi Haga, Nagoya-shi (JP); Masaki Furukawa, Toyota-shi (JP); Keita Yamashita, Nagoya-shi (JP); Ryuto Sakamoto, Okazaki-shi (JP); Hideyuki Nagai, Nagoya-shi (JP)

(73) Assignee: TOYOTA JIDOSHA KABUSHIKI KAISHA, Toyota-shi (JP)

(21) Appl. No.: 19/260,838

(22) Filed: Jul. 7, 2025

(30) Foreign Application Priority Data
Oct. 16, 2024 (JP) 2024-180954

(51) Int. Cl. H01M 4/70; H01M 4/66

(52) U.S. Cl. CPC H01M 4/70; H01M 4/667; H01M 4/668

(57) ABSTRACT

A current collector includes a support layer, a first electrically conductive layer, and a first adhesion layer. The support layer is composed of a resin composition having electric insulation. The first electrically conductive layer is laminated on the support layer through the first adhesion layer. The first electrically conductive layer includes a first surface. The first surface faces the first adhesion layer. The first surface has been subjected to a chemical surface roughening treatment.

### CROSS-REFERENCE TO RELATED APPLICATION

This application claims priority to Japanese Patent Application No. 2024-180954 filed on Oct. 16, 2024. The disclosure of the above-identified application, including the specification, drawings, and claims, is incorporated by reference herein in its entirety.

### BACKGROUND

### 1. Technical Field

The present disclosure relates to a current collector and a battery.

### 2. Description of Related Art

Japanese Unexamined Patent Application Publication (Translation of PCT Application) No. 2024-510696 (JP 2024-510696 A) discloses a conventional polar plate. The polar plate includes a current collector, an active material layer, and an electric connection member. The current collector includes a support layer and an electrically conductive layer. The support layer is composed of an electrically insulating material. The electrically conductive layer is provided on one surface of the support layer. The electrically conductive layer is formed by a method such as vacuum deposition, mechanical roll press, or adhesion.

### SUMMARY

There is room for improvement in the enhancement of the adhesion force between the support layer and the electrically conductive layer in the current collector. The present disclosure has been made in view of the problem, and has an object to provide a current collector in which the adhesion force between the support layer and the electrically conductive layer is enhanced, and a battery including the current collector.

A current collector according to an aspect of the present disclosure includes a support layer, a first electrically conductive layer, and a first adhesion layer. The support layer is composed of a resin composition having electric insulation. The first electrically conductive layer is laminated on the support layer through the first adhesion layer. The first electrically conductive layer includes a first surface. The first surface faces the first adhesion layer. The first surface has been subjected to a chemical surface roughening treatment.

A battery according to an aspect of the present disclosure includes an electrode body and an external terminal. The electrode body includes a first electrode, a second electrode, and a separator. The first electrode includes a current collector and an active material layer. The current collector includes a support layer, a first electrically conductive layer, and a first adhesion layer. The support layer is composed of a resin composition having electric insulation. The first electrically conductive layer is laminated on the support layer through the first adhesion layer. The first electrically conductive layer includes a first surface and a second surface. The first surface faces the first adhesion layer. The first surface has been subjected to a chemical surface roughening treatment. The second surface faces in a direction opposite to the first surface. The active material layer is laminated on the second surface. The separator is laminated on the active material layer. The second electrode is laminated on the active material layer through the separator. The external terminal is electrically connected with the first electrically conductive layer.

With the present disclosure, it is possible to enhance the adhesion force between the support layer and the electrically conductive layer.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a sectional view showing a battery according to an embodiment;

FIG. 2 is a sectional view of an electrode body as viewed in a direction of arrow line II-II in FIG. 1;

FIG. 3 is a developed view of a first electrode in the embodiment; and

FIG. 4 is a partial sectional view of the first electrode as viewed in a direction of arrow line IV-IV in FIG. 3.

### DETAILED DESCRIPTION OF EMBODIMENTS

A current collector and a battery according to an embodiment of the present disclosure will be described below with reference to the drawings. In the figures, identical or corresponding portions are denoted by identical reference characters, and descriptions thereof are not repeated.

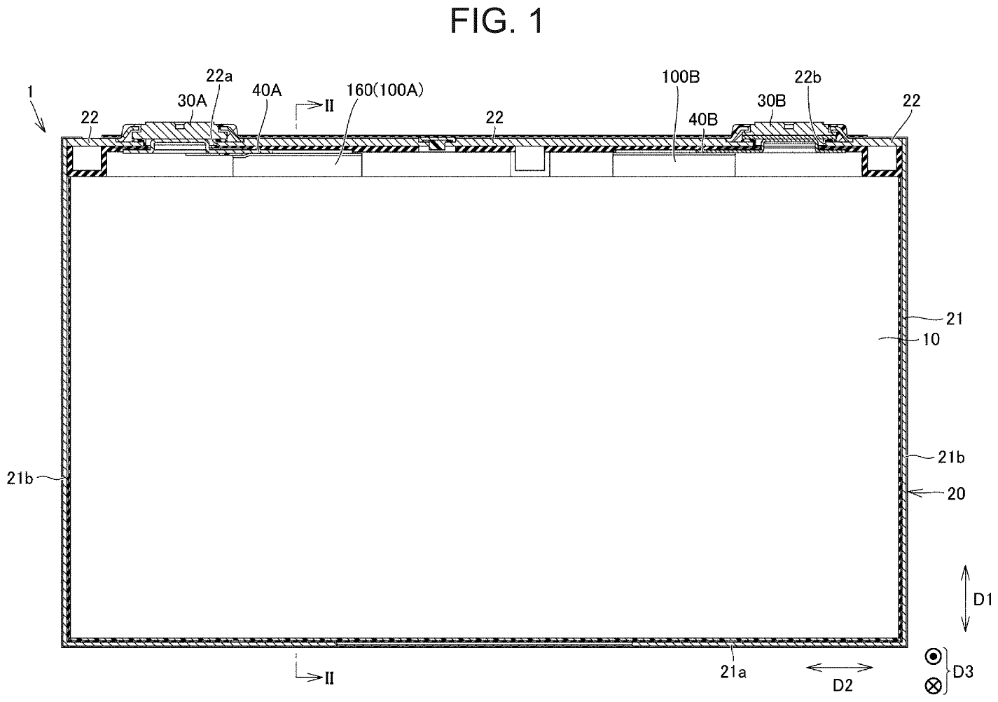

FIG. 1 is a sectional view showing a battery according to an embodiment. A battery 1 shown in FIG. 1 is a so-called rectangular battery. The battery 1 may be a secondary battery configured such that charging and discharging can be performed, as exemplified by a lithium-ion battery and a nickel-hydrogen battery. For example, the battery 1 can be used as a cell included in an electricity storage module that is mounted on an electrified vehicle.

As shown in FIG. 1, the battery 1 according to the embodiment of the present disclosure includes an electrode body 10, a case 20, a first external terminal 30A, a second external terminal 30B, a first coupling member 40A, and a second coupling member 40B. First, constituents of the battery 1 other than the electrode body 10 will be described.

The case 20 has electric conductivity. A portion of the case 20 that has electric conductivity is composed of a metal such as aluminum, for example. The case 20 houses the electrode body 10. The case 20 also houses an unillustrated electrolytic solution.

The case 20 includes a case body 21 and a lid 22. The case body 21 includes a bottom wall 21a and a peripheral wall 21b that stands from the bottom wall 21a.

The lid 22 is joined to the peripheral wall 21b by welding or the like, so as to close an opening of the peripheral wall 21b. On the lid 22, a first coupling hole 22a and a second coupling hole 22b are formed.

The first external terminal 30A and the second external terminal 30B are provided on the battery 1, so as to be exposed to the exterior. The first coupling member 40A and the second coupling member 40B have electric conductivity. At least a part of the first coupling member 40A and at least a part of the second coupling member 40B are disposed in the interior of the case 20.

The first external terminal 30A or the first coupling member 40A is inserted into the first coupling hole 22a. The first external terminal 30A is electrically connected with the first coupling member 40A. Specifically, the first external terminal 30A and the first coupling member 40A are joined to each other. The first coupling member 40A is joined to the electrode body 10. Thereby, the first external terminal 30A is electrically connected with the electrode body 10.

The second external terminal 30B or the second coupling member 40B is inserted into the second coupling hole 22b. The second external terminal 30B is electrically connected with the second coupling member 40B. Specifically, the second external terminal 30B and the second coupling member 40B are joined to each other. The second coupling member 40B is joined to the electrode body 10. Thereby, the second external terminal 30B is electrically connected with the electrode body 10.

In the embodiment, the first external terminal 30A is a positive electrode terminal, and the second external terminal 30B is a negative electrode terminal. The first external terminal 30A and the second external terminal 30B are arrayed in a second direction D2. The second direction D2 is a direction orthogonal to a first direction D1.

Next, the electrode body 10 will be described. The battery 1 according to the embodiment includes a plurality of electrode bodies 10. Typically, the battery 1 includes two electrode bodies 10. The electrode bodies 10 are arrayed in a third direction D3. The third direction D3 is a direction orthogonal to both of the first direction D1 and the second direction D2.

One electrode body 10 of the electrode bodies 10 will be described below. Each of the electrode bodies 10 may have the following configuration.

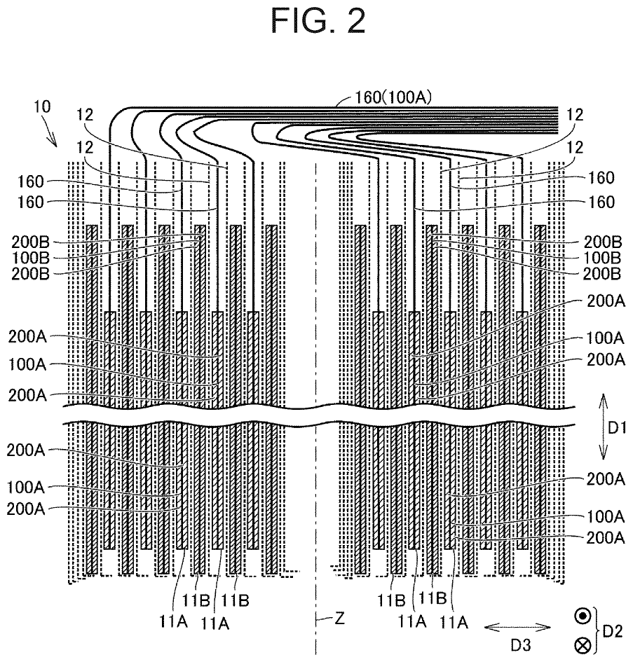

FIG. 2 is a sectional view of the electrode body as viewed in a direction of arrow line II-II in FIG. 1. As shown in FIG. 1 and FIG. 2, the electrode body 10 includes a first electrode 11A, a second electrode 11B, and a separator 12. In the electrode body 10, the first electrode 11A, the second electrode 11B, and the separator 12 are wound so as to surround the periphery of a winding axis line Z. In this way, in the embodiment, the electrode body 10 is a so-called wound electrode body. However, the electrode body 10 may be a laminated electrode body in which the first electrode 11A, the second electrode 11B, and the separator 12 are laminated in one direction (for example, the third direction D3). In FIG. 2, the separator 12 is schematically shown by broken lines.

Each external shape of the first electrode 11A and the second electrode 11B is a sheet shape. The electrode body 10 is constituted by a polar plate group in which the first electrode 11A and the second electrode 11B are wound through one or more separators 12. In the embodiment, the first electrode 11A is a positive electrode, and the second electrode 11B is a negative electrode. However, the first electrode 11A may be a negative electrode, and the second electrode 11B may be a positive electrode.

The separator 12 is provided between the first electrode 11A and the second electrode 11B. The separator 12 separates the first electrode 11A and the second electrode 11B, while allowing the movement of ions between the first electrode 11A and the second electrode 11B. The ions are lithium ions, for example. The separator 12 has electric insulation.

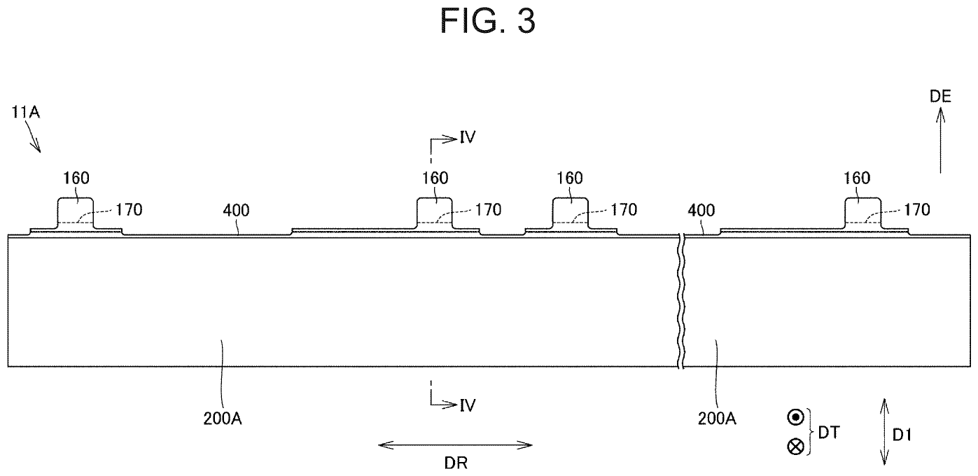

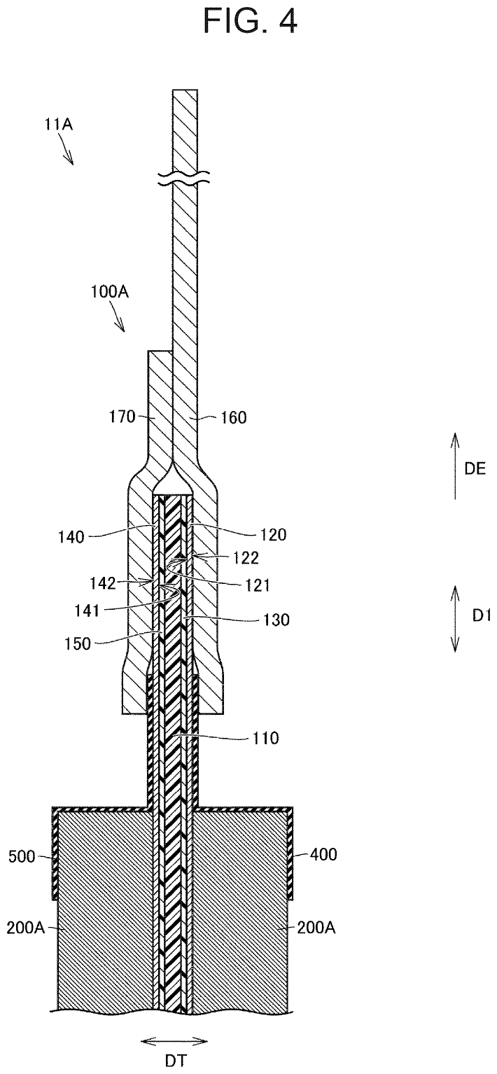

FIG. 3 is a developed view of the first electrode in the embodiment. That is, FIG. 3 shows a state before the first electrode 11A is wound. FIG. 4 is a partial sectional view of the first electrode as viewed in a direction of arrow line IV-IV in FIG. 3.

As shown in FIG. 2 to FIG. 4, the first electrode 11A includes a first current collector 100A, a pair of first active material layers 200A, a first protection portion 400, and a second protection portion 500.

The first current collector 100A includes a support layer 110, a first electrically conductive layer 120, a first adhesion layer 130, a second electrically conductive layer 140, a second adhesion layer 150, a plurality of tab portions 160, and a plurality of electric conduction assistance portions 170.

The support layer 110 is composed of a resin composition having electric insulation. Therefore, the first current collector 100A is a composite current collector constituted by an electrically conductive member and an electrically insulating member. Thereby, the first current collector 100A is lighter and the safety of the whole of the battery 1 is higher, compared to a case where the whole of the first current collector 100A is composed of a metal.

The support layer 110 is composed of a resin composition containing polyamide resin, polyester resin, or polyolefin resin, for example. For high stiffness, it is preferable that the support layer 110 is composed of a resin composition containing polyester resin. It is further preferable that the support layer 110 is substantially composed of polyester resin. The polyester resin may be polyethylene terephthalate, for example. Thereby, it is possible to increase the stiffness of the first current collector 100A, while maintaining the electric insulation of the support layer 110. Furthermore, it is possible to relatively thin the support layer 110.

A thickness direction DT of the support layer 110 is roughly orthogonal to the first direction D1. That is, the support layer 110 extends in a direction roughly orthogonal to the first direction D1.

For reducing the whole thickness of the electrode body 10, the thickness of the support layer 110, for example, preferably should be 20 μm or less, more preferably should be 15 μm or less, and further preferably should be 10 μm or less. The thickness of the support layer 110 is not particularly limited as long as there is a desired stiffness. For example, the thickness of the support layer 110 may be 2 μm or more.

The first electrically conductive layer 120 is laminated on the support layer 110 through the first adhesion layer 130. The first electrically conductive layer 120 is provided on one side of the support layer 110. The first electrically conductive layer 120 is provided so as to cover the whole of the one side of the support layer 110 as viewed from the thickness direction DT.

In the embodiment, the first electrically conductive layer 120 is positioned on the side of the winding axis line Z relative to the support layer 110. However, the first electrically conductive layer 120 may be positioned on the opposite side of the support layer 110 from the side of the winding axis line Z.

The first electrically conductive layer 120 includes a first surface 121 and a second surface 122. The first surface 121 faces the first adhesion layer 130. The first surface 121 contacts with the first adhesion layer 130. Typically, the whole of the first surface 121 contacts with the first adhesion layer 130.

The first surface 121 has been subjected to a chemical surface roughening treatment. Examples of the chemical surface roughening treatment includes an etching treatment and an anodization treatment.

It is preferable that an arithmetic average roughness Ra of the first surface 121 is 0.5 μm or less, for example. When the arithmetic average roughness Ra of the first surface 121 is 0.5 μm or less, an anchor effect for the first adhesion layer 130 is easily produced. The arithmetic average roughness Ra of the first surface 121 may be 0.2 μm or less or 0.1 μm or less. The arithmetic average roughness Ra of the first surface 121 may be 0.01 μm or more, for example.

The second surface 122 faces in a direction opposite to the first surface 121. The second surface 122 contacts with one of the first active material layers 200A. The second surface 122 contacts with the tab portions 160.

The second surface 122 has been subjected to a surface roughening treatment. Examples of the surface roughening treatment include a laser surface treatment, a sandblast treatment, and the above-described chemical surface roughening treatment. Further, the second surface 122 may have been subjected to a surface modification treatment such as a corona discharge treatment, a plasma treatment, or a UV irradiation treatment.

The arithmetic average roughness Ra of the second surface 122 is larger than the arithmetic average roughness Ra of the first surface 121. It is preferable that the arithmetic average roughness Ra of the second surface 122 is 1 μm or more, for example. When the arithmetic average roughness Ra of the second surface 122 is 1 μm or more, active material particles contained in the first active material layer 200A are easily fit.

The first adhesion layer 130 is provided on one surface of the support layer 110. The first adhesion layer 130 is provided over the whole of the one surface of the support layer 110.

The second electrically conductive layer 140 and the second adhesion layer 150 are positioned on the opposite side of the support layer 110 from the first electrically conductive layer 120 and the first adhesion layer 130.

The second electrically conductive layer 140 is laminated on the support layer 110 through the second adhesion layer 150. The second electrically conductive layer 140 is provided on the other side of the support layer 110. The second electrically conductive layer 140 is provided so as to cover the whole of the other side of the support layer 110 as viewed from the thickness direction DT.

The second electrically conductive layer 140 includes a third surface 141 and a fourth surface 142. The third surface 141 faces the second adhesion layer 150. The third surface 141 contacts with the second adhesion layer 150. Typically, the whole of the third surface 141 contacts with the second adhesion layer 150.

The third surface 141 has been subjected to a chemical surface roughening treatment. Examples of the chemical surface roughening treatment includes an etching treatment and an anodization treatment.

It is preferable that the arithmetic average roughness Ra of the third surface 141 is 0.5 μm or less, for example. When the arithmetic average roughness Ra of the third surface 141 is 0.5 μm or less, an anchor effect for the second adhesion layer 150 is easily produced. The arithmetic average roughness Ra of the third surface 141 may be 0.2 μm or less or 0.1 μm or less. The arithmetic average roughness Ra of the third surface 141 may be 0.01 μm or more, for example.

The fourth surface 142 faces in a direction opposite to the third surface 141. The fourth surface 142 contacts with the other of the first active material layers 200A. The fourth surface 142 contacts with the electric conduction assistance portions 170.

The fourth surface 142 has been subjected to a surface roughening treatment. Examples of the surface roughening treatment include a laser surface treatment, a sandblast treatment, and the above-described chemical surface roughening treatment. Further, the fourth surface 142 may have been subjected to a surface modification treatment such as a corona discharge treatment, a plasma treatment, or a UV irradiation treatment.

The arithmetic average roughness Ra of the fourth surface 142 is larger than the arithmetic average roughness Ra of the third surface 141. It is preferable that the arithmetic average roughness Ra of the fourth surface 142 is 1 μm or more, for example. When the arithmetic average roughness Ra of the fourth surface 142 is 1 μm or more, active material particles contained in the first active material layer 200A are easily fit.

The second adhesion layer 150 is provided on the other surface of the support layer 110. The second adhesion layer 150 is provided over the whole of the other surface of the support layer 110.

A method for forming the first electrically conductive layer 120 and the second electrically conductive layer 140 is not particularly limited. In the embodiment, typically, each of the first electrically conductive layer 120 and the second electrically conductive layer 140 is constituted by a metal film. Typically, the metal film may be produced by extrusion molding. Further, typically, each of the first electrically conductive layer 120 and the second electrically conductive layer 140 is composed of a metal containing aluminum. Thereby, the first current collector 100A including the first electrically conductive layer 120 and the second electrically conductive layer 140 can be suitably used as a positive electrode current collector. The first current collector 100A may be a negative electrode current collector, and each of the first electrically conductive layer 120 and the second electrically conductive layer 140 may be composed of a metal containing copper.

The thickness of the first electrically conductive layer 120 and the thickness of the second electrically conductive layer 140 are smaller than the thickness of the support layer 110. For reducing the whole thickness of the electrode body 10, the thickness of the first electrically conductive layer 120 and the thickness of the second electrically conductive layer 140, for example, are 5 μm or less, more preferably should be 2 μm or less, and further preferably should be 1 μm or less. For restraining the electric resistance of the first electrically conductive layer 120 and the second electrically conductive layer 140 from being excessively high, the thickness of the first electrically conductive layer 120 and the thickness of the second electrically conductive layer 140 may be 0.1 μm or more, for example. In the case where the thickness of the first electrically conductive layer 120 and the thickness of the second electrically conductive layer 140 are 5 μm or less, it is difficult for the first electrically conductive layer 120 and the second electrically conductive layer 140 to be directly welded to each other or to be directly joined to each other by ultrasonic welding.

Further, the first adhesion layer 130 and the second adhesion layer 150 are not particularly limited as long as there is adhesion property. Typically, the first adhesion layer 130 and the second adhesion layer 150 are composed of an adhesive agent containing resin. As the resin contained in the adhesive agent, for example, phenol resin, epoxy resin, melamine resin, urea resin, urethane resin, alkyd resin, silicone resin, unsaturated polyester resin, polyolefin resin, polyimide resin, acryl resin, or the like can be used, and only one kind may be used or a combination of two or more kinds may be used. Among them, it is preferable to use at least one kind selected from the group consisting of epoxy resin, urethane resin, silicone resin, polyolefin resin, and acryl resin. By using the resin in the group, it is possible to realize a more suitable adhesion strength.

Each thickness of the first adhesion layer 130 and the second adhesion layer 150 may be 0.5 μm or more, 1 μm or more, 2 μm or more, or 3 μm or more, for example. Each thickness of the first adhesion layer 130 and the second adhesion layer 150 may be 10 μm or less, 5 μm or less, or 3 μm or less, for example.

As shown in FIG. 3, the tab portions 160 are arrayed in a winding direction DR of the electrode body 10. The electric conduction assistance portions 170 are arrayed in the winding direction DR of the electrode body 10. The tab portions 160 are away from each other. The electric conduction assistance portions 170 are away from each other. The electric conduction assistance portions 170 are arrayed so as to correspond to the tab portions 160 in the thickness direction DT in a one-to-one manner.

Moreover, as shown in FIG. 2, the tab portions 160 are arrayed in the third direction D3. The tab portions 160 are joined to each other by ultrasonic joining or the like. Furthermore, as shown in FIG. 1, the tab portions 160 are joined to the first coupling member 40A by ultrasonic joining or the like. Thereby, the first external terminal 30A is electrically connected with the tab portions 160. In addition, the first external terminal 30A is electrically connected with the first electrically conductive layer 120 and the second electrically conductive layer 140. The configuration of each of the tab portions 160 and the configuration of each of the electric conduction assistance portions 170 will be described below.

The tab portion 160 is connected with the first electrically conductive layer 120. Typically, the tab portion 160 is directly joined to the first electrically conductive layer 120. For example, the tab portion 160 is joined to the first electrically conductive layer 120 by ultrasonic welding. The tab portion 160 extends on the first electrically conductive layer 120 along the first direction D1. The tab portion 160 extends so as to be away from the first electrically conductive layer 120. An extension direction DE of the tab portion 160 is substantially parallel to the first direction D1. Further, the tab portion 160 may be directly joined to the first external terminal 30A.

The electric conduction assistance portion 170 is connected with the second electrically conductive layer 140. Typically, the electric conduction assistance portion 170 is directly joined to the second electrically conductive layer 140. For example, the electric conduction assistance portion 170 is joined to the second electrically conductive layer 140 by ultrasonic welding. An end portion of the electric conduction assistance portion 170 in the extension direction DE is joined to the tab portion 160 by ultrasonic welding.

Each of the tab portion 160 and the electric conduction assistance portion 170 is constituted by a film-formed member. Typically, each of the tab portion 160 and the electric conduction assistance portion 170 is constituted by a metal film containing aluminum, copper, or the like.

Each thickness of the tab portion 160 and the electric conduction assistance portion 170 is larger than the thickness of the first electrically conductive layer 120 and the thickness of the second electrically conductive layer 140. Each thickness of the tab portion 160 and the electric conduction assistance portion 170, for example, preferably should be 20 μm or less, more preferably should be 15 μm or less, and further preferably should be 10 μm or less. Each thickness of the tab portion 160 and the electric conduction assistance portion 170 is not particularly limited as long as there is a desired stiffness. Each thickness of the tab portion 160 and the electric conduction assistance portion 170 may be 2 μm or more.

The first active material layers 200A are laminated on the second surface 122 and the fourth surface 142, respectively. Each of the first active material layers 200A contains a plurality of binder particles and a plurality of active material particles. Typically, each of the active material particles contains a positive electrode active material. Examples of the positive electrode active material may include at least one kind selected from the group consisting of LiCoO₂, LiNiO₂, LiMnO₂, LiMn₂O₄, Li(NiCoMn)O₂, Li(NiCoAl)O₂, LiFePO₄, LiMn_{0.5}Fe_{0.5}PO₄, LiMnPO₄, LiNiPO₄, and LiCoPO₄. For example, “(NiCoMn)” in “Li(NiCoMn)O₂” means that the total of composition ratios in parentheses is 1. However, each of the active material particles may contain a negative electrode active material such as a graphite particle or a silicon oxide particle. For example, an average particle diameter D50 of the active material particles may be 0.01 μm or more, 0.1 μm or more, 0.5 μm or more, 1 μm or more, or 5 μm or more, and may be 50 μm or less, 30 μm or less, 20 μm or less, 10 μm or less, or 7.5 μm or less. The separator 12 is laminated on the first active material layer 200A in a radial direction from the winding axis line Z.

The first protection portion 400 is composed of a ceramic having electric insulation. The first protection portion 400 covers a part of the first active material layer 200A that is laminated on the first electrically conductive layer 120 and that is on a side in the extension direction DE. The first protection portion 400 covers the whole of the surface of the first electrically conductive layer 120 between the first active material layer 200A and the tab portion 160. The first protection portion 400 is partially disposed also between the first electrically conductive layer 120 and the tab portion 160.

The second protection portion 500 is composed of a ceramic having electric insulation. The second protection portion 500 covers a part of the first active material layer 200A that is laminated on the second electrically conductive layer 140 and that is on a side in the extension direction DE. The second protection portion 500 covers the whole of the surface of the second electrically conductive layer 140 between the first active material layer 200A and the electric conduction assistance portion 170. The second protection portion 500 is partially disposed also between the second electrically conductive layer 140 and the electric conduction assistance portion 170.

As shown in FIG. 2, the second electrode 11B is laminated on the first active material layer 200A through the separator 12 in the above radial direction. In the embodiment, the electrode body 10 includes a plurality of separators 12, but may include a single separator 12.

The second electrode 11B includes a second current collector 100B and second active material layers 200B. The second current collector 100B is pulled out from between the second active material layers 200B to one side in the first direction D1. The second current collector 100B is joined to the second coupling member 40B by ultrasonic welding (see FIG. 1).

The second current collector 100B is constituted by a metal film, for example. The second current collector 100B is composed of a metal containing copper, for example. Thereby, the second current collector 100B can be suitably used as a negative electrode current collector. In the case where the first current collector 100A is a negative electrode current collector and the second current collector 100B is a positive electrode current collector, the second current collector 100B may be composed of a metal containing aluminum. Further, the second current collector 100B may have the same configuration as the first current collector 100A.

The second active material layers 200B are laminated on both surfaces of the second current collector 100B. In the embodiment, the second electrode 11B is a negative electrode. Therefore, the second active material layer 200B is a negative electrode active material layer. The second active material layer 200B may be a positive electrode active material layer.

As described above, the first current collector 100A according to the embodiment of the present disclosure includes the support layer 110, the first electrically conductive layer 120, and the first adhesion layer 130. The support layer 110 is composed of a resin composition having electric insulation. The first electrically conductive layer 120 is laminated on the support layer 110 through the first adhesion layer 130. The first electrically conductive layer 120 includes the first surface 121. The first surface 121 faces the first adhesion layer 130. The first surface 121 has been subjected to the chemical surface roughening treatment.

With the above configuration, since the first surface 121 has been subjected to the chemical surface roughening treatment, the first adhesion layer 130 enters concave portions on the first surface 121. That is, an anchor effect for the first adhesion layer 130 is produced. Thereby, the adhesion force between the support layer 110 and the first electrically conductive layer 120 is enhanced.

Further, in the embodiment, the first electrically conductive layer 120 further includes the second surface 122. The second surface 122 faces in a direction opposite to the first surface 121. The second surface 122 has been subjected to the surface roughening treatment.

With the above configuration, active material particles contained in the first active material layer 200A are easily fit in concave portions on the second surface 122. Consequently, it is possible to enhance the adherence property between the second surface 122 and the first active material layer 200A further laminated on the second surface 122.

Further, in the embodiment, the arithmetic average roughness Ra of the second surface 122 is larger than the arithmetic average roughness Ra of the first surface 121. With the configuration, it is possible to cause the first surface 121 and the second surface 122 to have appropriate roughnesses depending on purposes, respectively. This is because it is preferable that the size of each concave portion for enhancing the adherence property with the first active material layer 200A is larger than the size of each concave portion for producing the anchor effect.

Further, in the embodiment, the first current collector 100A further includes the second electrically conductive layer 140 and the second adhesion layer 150. The second electrically conductive layer 140 and the second adhesion layer 150 are positioned on the opposite side of the support layer 110 from the first electrically conductive layer 120 and the first adhesion layer 130. The second electrically conductive layer 140 is laminated on the support layer 110 through the second adhesion layer 150. The second electrically conductive layer 140 includes the third surface 141 and the fourth surface 142. The third surface 141 faces the second adhesion layer 150. The third surface 141 has been subjected to the chemical surface roughening treatment. The fourth surface 142 faces in a direction opposite to the third surface 141. The fourth surface 142 has been subjected to the surface roughening treatment. The arithmetic average roughness Ra of the fourth surface 142 is larger than the arithmetic average roughness Ra of the third surface 141.

With the above configuration, since the third surface 141 has been subjected to the chemical surface roughening treatment, the second adhesion layer 150 enters concave portions on the third surface 141. That is, an anchor effect for the second adhesion layer 150 is produced. Thereby, the adhesion force between the support layer 110 and the second electrically conductive layer 140 is enhanced. Further, since the fourth surface 142 has been subjected to the surface roughening treatment, active material particles contained in the first active material layer 200A are easily fit in concave portions on the fourth surface 142. Consequently, it is possible to enhance the adherence property between the fourth surface 142 and the first active material layer 200A further laminated on the fourth surface 142. Furthermore, since the arithmetic average roughness Ra of the fourth surface 142 is larger than the arithmetic average roughness Ra of the third surface 141, it is possible to cause the third surface 141 and the fourth surface 142 to have appropriate roughnesses depending on purposes, respectively.

In the above description about the embodiment, configurations that can be combined may be mutually combined.

The embodiments disclosed herein should be considered in all respects as illustrative and not restrictive. The scope of the present disclosure is defined by the claims rather than the foregoing description, and is intended to include all changes that fall within the meaning and the scope equivalent to the claims.

What is claimed is:

1. A current collector comprising:
a support layer;
a first electrically conductive layer; and
a first adhesion layer, wherein:
the support layer is composed of a resin composition having electric insulation;
the first electrically conductive layer is laminated on the support layer through the first adhesion layer;
the first electrically conductive layer includes a first surface;
the first surface faces the first adhesion layer; and
the first surface has been subjected to a chemical surface roughening treatment.

2. The current collector according to claim 1, wherein:
the first electrically conductive layer further includes a second surface;
the second surface faces in a direction opposite to the first surface; and
the second surface has been subjected to a surface roughening treatment.

3. The current collector according to claim 2, wherein an arithmetic average roughness of the second surface is larger than an arithmetic average roughness of the first surface.

4. The current collector according to claim 3, further comprising:
a second electrically conductive layer; and
a second adhesion layer, wherein:
the second electrically conductive layer and the second adhesion layer are positioned on an opposite side of the support layer from the first electrically conductive layer and the first adhesion layer;
the second electrically conductive layer is laminated on the support layer through the second adhesion layer;
the second electrically conductive layer includes a third surface and a fourth surface;
the third surface faces the second adhesion layer;
the third surface has been subjected to a chemical surface roughening treatment;
the fourth surface faces in a direction opposite to the third surface;
the fourth surface has been subjected to a surface roughening treatment; and
an arithmetic average roughness of the fourth surface is larger than an arithmetic average roughness of the third surface.

5. A battery comprising:
an electrode body; and
an external terminal, wherein:
the electrode body includes a first electrode, a second electrode, and a separator;
the first electrode includes a current collector and an active material layer;
the current collector includes a support layer, a first electrically conductive layer, and a first adhesion layer;
the support layer is composed of a resin composition having electric insulation;
the first electrically conductive layer is laminated on the support layer through the first adhesion layer;
the first electrically conductive layer includes a first surface and a second surface;
the first surface faces the first adhesion layer;
the first surface has been subjected to a chemical surface roughening treatment;
the second surface faces in a direction opposite to the first surface;
the active material layer is laminated on the second surface;
the separator is laminated on the active material layer;
the second electrode is laminated on the active material layer through the separator; and
the external terminal is electrically connected with the first electrically conductive layer.
